(19) United States
(12) Patent Application Publication
(10) Pub. No.: US 2016/0350419 A1
(43) Pub. Date: Dec. 1, 2016

(54) METHOD AND DEVICE FOR PERFORMING REVERSE SEARCH USING CRUCIAL LINK

(71) Applicant: Delong TAO, Shenzhen (CN)

(72) Inventor: Delong TAO, Shenzhen (CN)

(21) Appl. No.: 15/108,511

(22) PCT Filed: Dec. 26, 2013
(86) PCT No.: PCT/CN2013/090519

§ 371 Date: Aug. 19, 2016

(51) Int. Cl. G06F 17/30

(52) U.S. Cl. CPC G06F 17/30864; G06F 17/30554; G06F 17/30899; G06F 17/30887

(57) ABSTRACT

A method and apparatus for using a key link to execute a reverse search, which relates to the technical field of Internet search engines. The method comprises: according to a received search request, triggering a search engine to perform a search, acquiring a search result, and establishing a reverse search entrance corresponding to the search result; generating a reverse search request aiming at a key link; obtaining a pre-set associated user corresponding to the key link; performing a reverse search again and obtaining an associated link of the associated user; and the user selects a required associated link to access, or performs the reverse search again. A search in a traditional manner may be executed according to an input search request, and a reverse search may also be performed aiming at one of the screened search results so as to improve search efficiency; and intelligently analysing a user search request according to a user screened object can adjust a search direction in time in the case where an initially input keyword is inaccurate or is indirectly associated with required information, so that information required by a user is searched for intelligently and quickly.

### FIELD OF THE INVENTION

The present invention relates to the technical field of Internet search engines.

### BACKGROUND OF THE INVENTION

All existing Internet search engines perform a forward search, as shown in FIG. 1, that is, a search engine only performs a forward search for associated results according to a manually input key word; the search engine provides some results, a user selects a key link in the results, and clicks and accesses the key link; however, in a search process, a user may often be unable to input a key word accurately associated with a required result due to various reasons; if more key words are input, the required result may not be searched out; if less key words are input, many search results may be presented, however, a displaying page can only display a limited number of search results, many times of page turning search operations may need to be continuously performed, and efficiency of the search work may below. In order to improve the efficiency of the search work, although some search engines can provide a secondary filter search, by which a required result can be quickly selected from a plurality of search results, the user still needs to manually input or select a corresponding key word before carrying out the selection; the selected targets are the previously searched results, however, if the key word input in the previous search is not associated with or not directly associated with the required result, the required result may not be searched out; moreover, there is a use inconvenience that a manual input or a manual selection may be needed, and thus the existing Internet search engines lacks intelligence.

### CONTENT OF THE INVENTION

As detailed above, a purpose of the present invention is solving a problem that existing search engines have a technical defect of low search efficiency and lacking intelligence, by providing a method and apparatus for using a key link to execute a reverse search.

In order to solve the technical problem raised by the present invention, a technical solution to be adopted is: a method for using a key link to execute a reverse search, wherein, the method comprises:

a: receiving a search request input by a user;

b: according to the received search request, triggering a search engine to perform a search, obtaining search results, and establishing a reverse search entrance corresponding to each of the search results;

c: by a user, selecting a link in the search results and taking the link as a key link, and generating a reverse search request aiming at the key link;

d: aiming at the reverse search request, actuating a search engine at the reverse search entrance and performing a reverse search, and obtaining a pre-set associated user corresponding to the key link;

e: aiming at the associated user provided by the search engine, performing the reverse search again, and obtaining associated links of the associated user;

f: according to the search result provided by the search engine, by the user, selecting a required associated link to access, or performing the reverse search again.

When the reverse search is performed according to a similar link element selected by the user, obtaining coincident webpages or coincident webpage codes of which the contents are coincident with the contents of webpages or webpage codes corresponding to the key link, and sequencing the coincident webpages or coincident webpage codes according to an order from a higher content comparison coincidence ratio to a lower content comparison coincidence ratio, and generating the corresponding search results.

When the reverse search is performed according to a common IP address factor selected by the user, obtaining all IP addresses corresponding to the key link, and when the reverse search aiming at one of the IP addresses is performed again, obtaining all associated links accessed by the IP address.

When the reverse search is performed according to a sharer factor selected by the user, obtaining all sharers corresponding to the key link; and when the reverse search aiming at one of the sharers is performed again, obtaining all associated links shared by the sharer.

An apparatus for implementing the method for using a key link to execute a reverse search, wherein, the apparatus comprises:

a web crawler module configured for grabbing webpages in the Internet;

a search engine database configured for storing webpages or webpage codes grabbed by the web crawler module;

a user information managing module configured for managing user information and establishing an information connection between the user information and associated links of the webpages and the webpage codes stored in the search engine database;

an input module configured for receiving a search request input by a user;

a retrieving module configured for searching in the search engine database according to the search request, and obtaining search results associated with the search request;

a displaying module configured for displaying the search results obtained by the retrieving module, and establishing a reverse search entrance corresponding to each of the search results simultaneously;

a reverse search module configured for obtaining associated information corresponding to the reverse search entrance from the search engine database according to the reverse search request, generating corresponding search results, and outputting the search results to the displaying module.

The present invention has advantageous effects as follows: the search method of the present invention can not only perform a search in a traditional manner according to an input search request, but also access a reverse search entrance corresponding to a search result and start a reverse search aiming at a selected one of the search results, thereby searching out information similar to the selected search result, such as similar links, or links having other common associated information factors. Thus, the search efficiency can be improved; according to an object selected by the user, the search request of the user is intelligently analyzed, it is possible that a search direction can be adjusted in time when a first input key word is inaccurate or is indirectly associated with required information, and thus information required by the user can be intelligently and quickly searched out.

### BRIEF DESCRIPTION OF THE DRAWINGS

FIG. 1 illustrates a general working flow chart of an existing search method;

FIG. 2 illustrates a general working flow chart of a search method in the present invention;

FIG. 3 illustrates a flow chart of specific steps of a first embodiment of the present invention;

FIG. 4 illustrates a structural schematic view of a search result of a second embodiment of the present invention;

FIG. 5 illustrates a structural schematic view of a search result of a third embodiment of the present invention;

FIG. 6 illustrates a flow chart of specific steps of a fourth embodiment of the present invention;

FIG. 7 illustrates a flow chart of specific steps of a fifth embodiment of the present invention;

FIG. 8 illustrates a flow chart of specific steps of a sixth embodiment of the present invention;

FIG. 9, FIG. 10, and FIG. 11 illustrate flow charts of other three representation modes of the general work of the search method of the present invention respectively;

FIG. 12 illustrates a working flow chart of a reverse search module;

FIG. 13 illustrates a structural schematic view of using a similar link factor to perform a reverse search in the present invention.

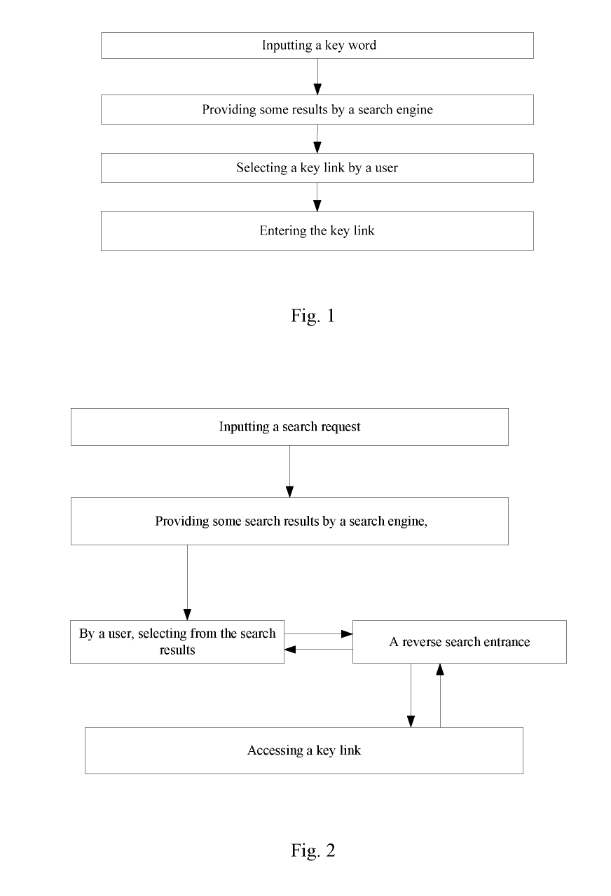

### DETAILED DESCRIPTION OF THE PREFERRED EMBODIMENT

The present invention will be further described hereinafter with reference to the accompanying drawings and the specific embodiments recited in the present invention.

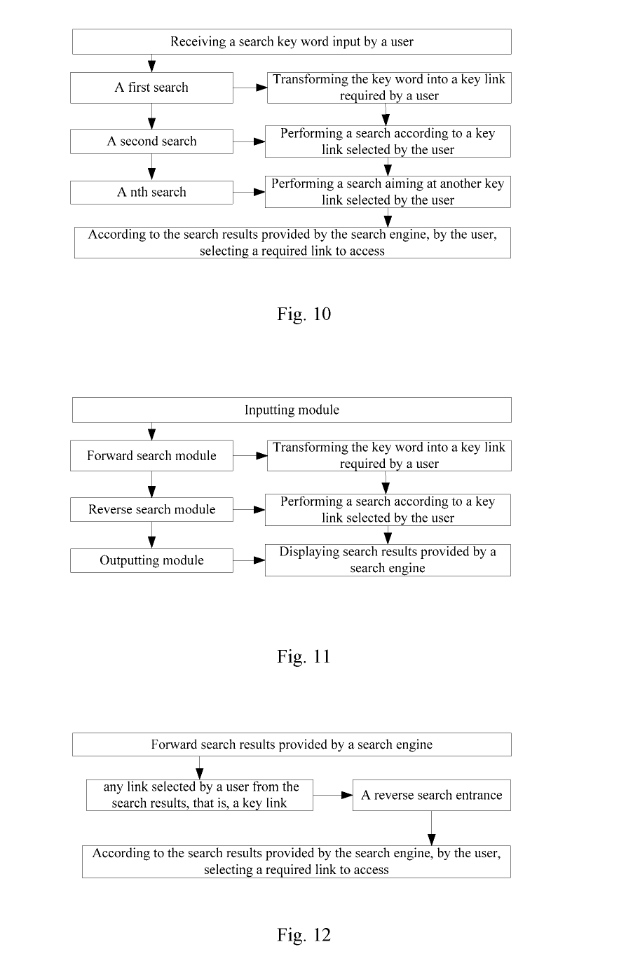

Please refer to FIG. 2, FIG. 9, FIG. 10, FIG. 11 or FIG. 12, as shown in these figures, a method for using a key link to execute a reverse search of the present invention comprises the following steps:

a: receiving a search request input by a user; the search request can be a key word, a key phrase, a pre-set code, or a link input by the user.

b: according to the received search request, triggering a search engine to perform a search, obtaining search results, and establishing a reverse search entrance corresponding to each of the search results; the search results provided by the search engine comprise links associated with the search request; each of the search results corresponds to a reverse search entrance, the user can selectively click a link in any one of the search results to directly open a page corresponding to the link, and can also access through any of the reverse search entrances.

c: by the user, selecting a link in the search results and using the link as a key link, and aiming at the key link, generating a reverse search request; that is, when the user judges that none of the search results obtained in the step b is directly associated with required information, but some of the search results may be indirectly associated with the required information, or when a common information factor exists in both the search results and the required information, one of the search results is selected, and a link in the selected search result is used as the key link; aiming at the key link, a reverse search request is generated again.

d: aiming at the reverse search request, actuating a search engine at a reverse search entrance to perform the reverse search, and obtaining a pre-set associated user corresponding to the key link; that is, when the reverse search entrance is clicked, the search engine is actuated, or a reverse search module of the search engine is actuated; meanwhile, aiming at the reverse search request generated in the step c, the reverse search is performed, and associated user information corresponding to the key link and predefined in a search engine database of the search engine is obtained, or the search engine database has stored records indicating that the key link has been accessed or stored by the associated user.

e: aiming at the associated user provided by the search engine, performing the reverse search again, and obtaining the key link of the associated user; there may be one or a plurality of associated user(s) obtained in the step of d; when there are a plurality of associated users, one of the associated users is selected, and by directly clicking the selected associated user or clicking a corresponding reverse search entrance, performing the reverse search aiming at the selected associated user, and thereby obtaining all links accessed or stored by the associated user.

f: according to the search results provided by the search engine, by the user, selecting the required key link to access or performing the reverse search again.

In the method for using a key link to execute a reverse search in the present invention, when a reverse search is performed again in the aforesaid step f, tags can be used to select one of the factors, such as a similar link factor, a common IP address factor, a sharer factor, and so on, so as to perform the reverse search.

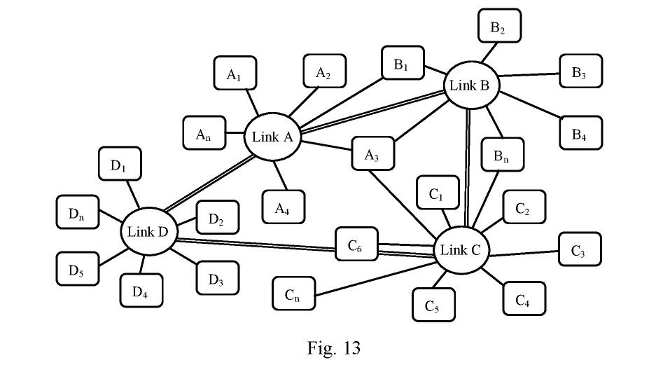

When the user selects the similar link factor to perform the reverse search, as shown in FIG. 13, coincidence webpages or coincidence webpage codes of which the contents are coincident with that of the webpages or webpage codes corresponding to the key link are obtained and sequenced in an order from a higher content comparison coincidence ratio to a lower content comparison coincidence ratio, and a corresponding search result is generated. That is, in the search engine database, the coincidence webpages or webpage codes of which the contents are coincident with the contents of the webpages or webpage codes corresponding to the key link are searched out by a coincidence comparing method, and are sequenced according to the order from a higher content coincidence ratio to a lower content coincidence ratio; afterwards, the links corresponding to the coincidence webpages or webpage codes are output to generate corresponding search results. In a process of implementation, a step of using the similar link factor to perform the reverse search can also be used to replace the aforesaid step d and step e.

When the user selects the common IP address factor to perform the reverse search, as shown in FIG. 4, all IP (Internet Protocol) addresses corresponding to the key link are obtained; when the reverse search is performed aiming at one of the IP addresses, all associated links accessed by the IP address are obtained. Since when other non-login users use links accessed by the search engine of the present invention, the search engine database only records association information between the IP addresses and the associated links, by tracking footprints of the IP addresses, the associated links required by the user may be found.

When the user selects the shared factor to perform the reverse search, all sharers corresponding to the key link are obtained; when the reverse search is performed again aiming at one of the sharers, all associated links shared by the sharer are obtained. This search method can be interpreted as a search method based on common interests and hobbies, in the absence of an input key word, a great many homogeneous search results can be searched out.

In the process of specific implementation, the aforesaid step d and step e can also be replaced by a step of using the similar link factor, the common IP address factor, or the sharer factor to perform the reverse search.

A device for implementing the method for using the key link to execute the reverse search in the present invention, the device is actually a search engine which comprises:

a web crawler module configured for grabbing webpages in the Internet;

a search engine database configured for storing webpages, webpage codes, and relevant information factors grabbed by the web crawler module;

a user information managing module configured for managing user information, and establishing an information connection between the user information and the key links of the webpages and webpage codes stored in the search engine database; that is, receiving a registration request submitted by a user, managing user registration information, and recording links accessed and browsed by a registered user, links stored by the user, links shared by the user, and other relevant information, such as moments of the user; an input module configured for receiving a search request input by the user;

a retrieving module configured for searching in the search engine database according to the search request, and obtaining search results associated with the search request; the search results can be information such as links, IP addresses, user names, and so on;

a displaying module configured for displaying the search results obtained by the retrieving module, and establishing a reverse search entrance corresponding to each of the search results simultaneously;

a reverse search module configured for obtaining associated information corresponding to the reverse search entrance from the search engine database according to the reverse search request, generating corresponding search results, and outputting the search results to the displaying module.

The present invention will be described hereinafter according to operation flows of some specified embodiments.

### Embodiment I

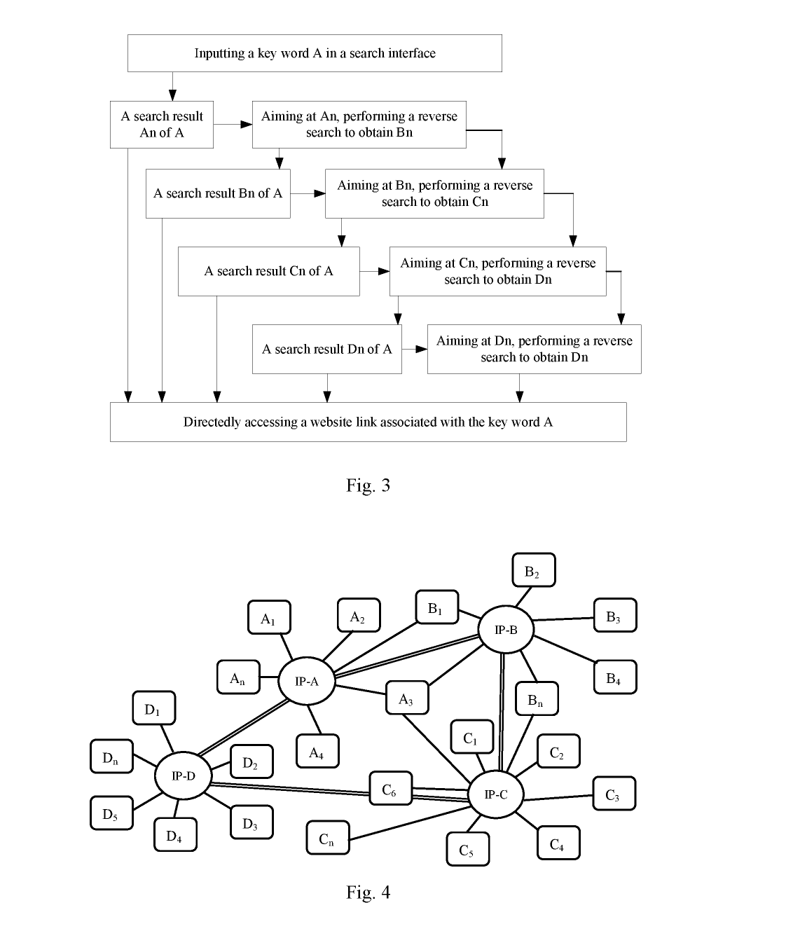

Please refer to FIG. 3, as shown in the FIG. 3, a key word A is input into an input module of a search interface, i.e., a search engine, and an arbitrary result An is obtained; a reverse search is performed aiming at the arbitrary search result An of A, and an arbitrary result Bn associated with An is obtained; aiming at the arbitrary result Bn of An, the reverse search is performed again, and an arbitrary result Cn associated with Bn is obtained; aiming at the arbitrary search result Cn, the reverse search is performed again, and a result Dn associated with Cn is obtained . . . in this way, a cyclic search is generated, and any search result is inevitably directly or indirectly associated with the key word A.

The method has made a breakthrough in the problem that a traditional search engine can only provide a forward search result aiming at a “key word”, and the search engine perform reverse and periodical searches aiming at the “key word”; in this method, by reversely tracing the search result “the key link” of the “key word”, a search result that is closer to a user requirement can be obtained; meanwhile, by reversely searching the search result “the key link” of the “key word”, an original producer, an owner, a broadcaster, a collector, a sharer, and a circle of friends of this “key link” can be traced; furthermore, aiming at the original producer, the owner, the broadcaster, the collector, the sharer, and the circle of friends of this “key link”, the reverse search can be performed again, and search results that are closer to the user requirement are obtained; at the same time, the search engine is enabled to generate social communication value. That is, the reverse search is performed aiming at the search result “key link” of the search results of the “key word”, such that the search results provided by the search engine are more associated, accurate, realistic, diversified, and intensive.

### Embodiment II

Please refer to FIG. 4, as shown in the FIG. 4, a common IP address factor is selected to perform a reverse search, a search is performed aiming at a key word A, and associated links A1-An are obtained; an associated link A3 is used as a key link, the reverse search is further performed aiming at the key link A3, and associated links B1-Bn and C1-Cn can be obtained; that is, it is indicated that the record information indicating that the key link A3 has been accessed by IP addresses IP-A, IP-B and IP-C is stored in a search engine database, wherein, IP address IP-A has accessed the associated links A1-An, the IP address IP-B has accessed the associated links B1-Bn, and the IP address IP-C has accessed the associated links C1-Cn.

A search is performed aiming at a key word B, and the associated links B1-Bn can be obtained; an associated link B1 in the search result of the key word B is used as a key link, the reverse search is further performed aiming at the key link B1, and the associated links A1-An can be obtained; the reverse search is performed aiming at a key link Bn, and thus the associated links C1-Cn can be obtained.

A search is performed aiming at a key word C, and the associated links C1-Cn can be obtained; the reverse search is further performed aiming at the associated links C1-Cn, and all links that have ever been accessed by the IP address IP-C can be obtained; the links includes the accessed associated link A3, Bn; the reverse search is performed aiming at the associated link Bn, and the associated links Bl-Bn can be obtained; the reverse search is further performed aiming at the associated link A3, and the associated links A1-An and the associated links B1-Bn can be obtained.

A search is performed aiming at a key word D and an associated links D1-Dn can be obtained, the reverse search is further performed aiming at the associated links D1-Dn and an IP address IP-D can be obtained; if there is no any other associated links other than the associated links D1-Dn, the reverse search cannot be further performed.

### Embodiment III

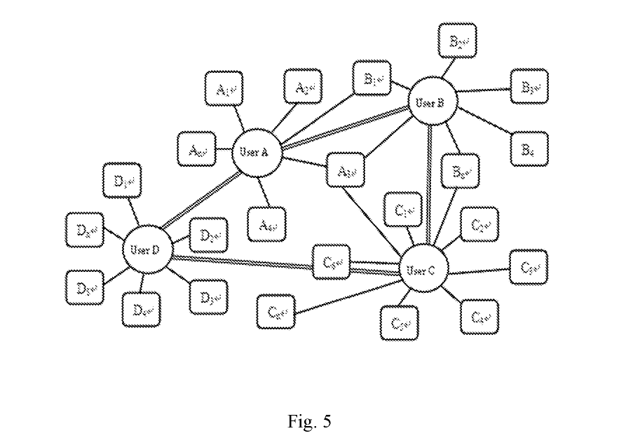

As shown in the FIG. 5, a common user factor is selected to perform a reverse search, that is, the reverse search is performed aiming at the common user ID (Identity) factor; a search is performed aiming at a key word A, and associated links A1-An can be obtained; a reverse search is performed aiming at an associated link Al, and an account number of an associated user A, that is, the user's ID number, can be obtained; the reverse search is further performed aiming at the account number of the user A, and an associated link B1 can be obtained, that is, according to the account number of the user A, it can be known that the user A has also accessed the associated link B1; the reverse search is continuously performed aiming at the associated link B1, and an account number of an associated user B can be obtained; the reverse search is further continuously performed aiming at the account number of the user B, and associated links B1-Bn+A3 can be obtained; the reverse search is further continuously performed aiming at an associated link Bn, and an account number of a user C can be obtained; afterwards, a reverse search is further performed aiming at the account number of the user C and associated links C1-Cn+A3 can be obtained.

According to the aforesaid principle, a search is performed aiming at the key word A, and the associated links A1-An can be obtained; the reverse search is further performed aiming at the associated link A3 of the search results of the key word A, the account numbers of the user A, the user B, the user C and associated links of these account numbers can be obtained simultaneously.

In a same way, a search is performed aiming at the key word B and the associated links B1-Bn can be obtained; the reverse search is further performed aiming at the associated link B1 of the search results of the key word B, and account numbers of the users A and B and associated links of these account numbers can be obtained simultaneously; the reverse search is further performed aiming at the associated link Bn, and account numbers of the users B and C and associated links of these account numbers can be obtained simultaneously.

In the same way, a search is performed aiming at the key word C, and the associated links A3 and Bn can also be obtained by tracing in a reverse direction; a reverse search is further performed aiming at the associated link A3, and account numbers of the users A, B, and C and the associated links of these account numbers can be obtained simultaneously; a reverse search is further performed aiming at the associated link Bn, and the account numbers of the users B, C and associated links of these account numbers can be obtained simultaneously.

In the same way, a search and a reverse tracing are performed aiming at the key word D, and thus an account number of the user D and associated links thereof can be obtained simultaneously.

### Embodiment IV

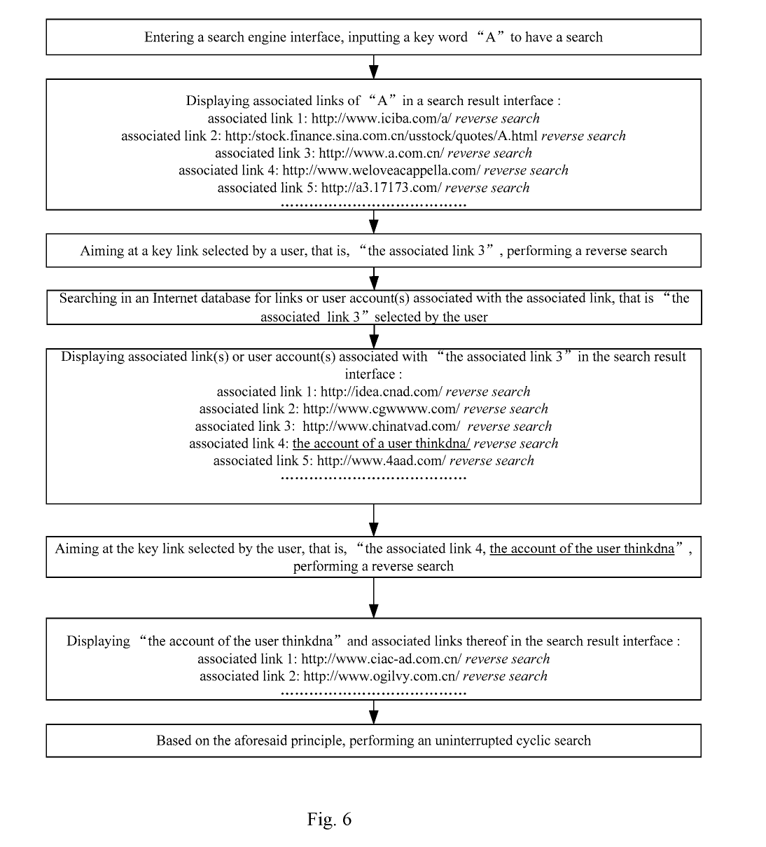

As shown in the FIG. 6, a search engine interface is entered, and a key word “A” is input to perform a search, a search result interface shows a plurality of associated links including “A”, and each of the associated links corresponds to a reverse search entrance configured for performing a reverse search, that is, the “reverse search” shown in the figure; the reverse search is performed aiming at an associated link 3 selected by the user, that is, a position of the “reverse search” shown in the figure is clicked, a retrieving module obtains links or user accounts associated with the associated link 3 from a search engine database, and a plurality of links or user accounts associated with the associated link 3 can be obtained again; for example, if a user account “thinkdna” is selected to perform the reverse search, the account of the internet user “thinkdna” and associated links thereof are shown; according to the aforesaid principle, an uninterrupted cyclic search can be performed.

### Embodiment V

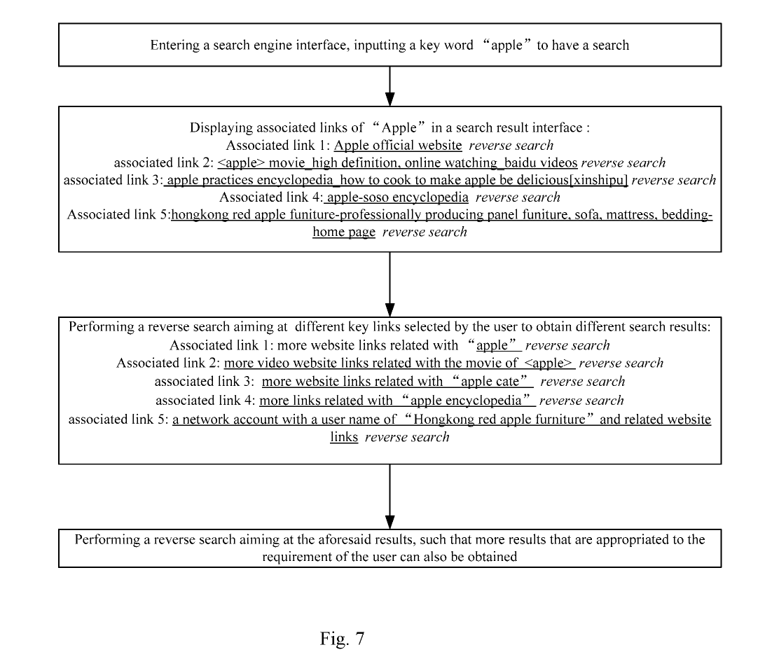

As shown in the FIG. 7, a search engine interface is entered, a key word “apple” is input to perform a search, then links associated with Apple inc., links associated with a movie named “apple”, links associated with apples of the fruit, and links associated with the furniture branded with Apple can be obtained; the displayed search results traverse many different categories, obtaining a required key link by a direct selection will lead to a huge workload; however, when a reverse search is performed aiming at a key link selected by the user, according to corresponding associated link information selected by the user, homogeneous associated links can be searched out again, and many associated links in irrelevant categories can be intelligently filtered off.

### Embodiment VI

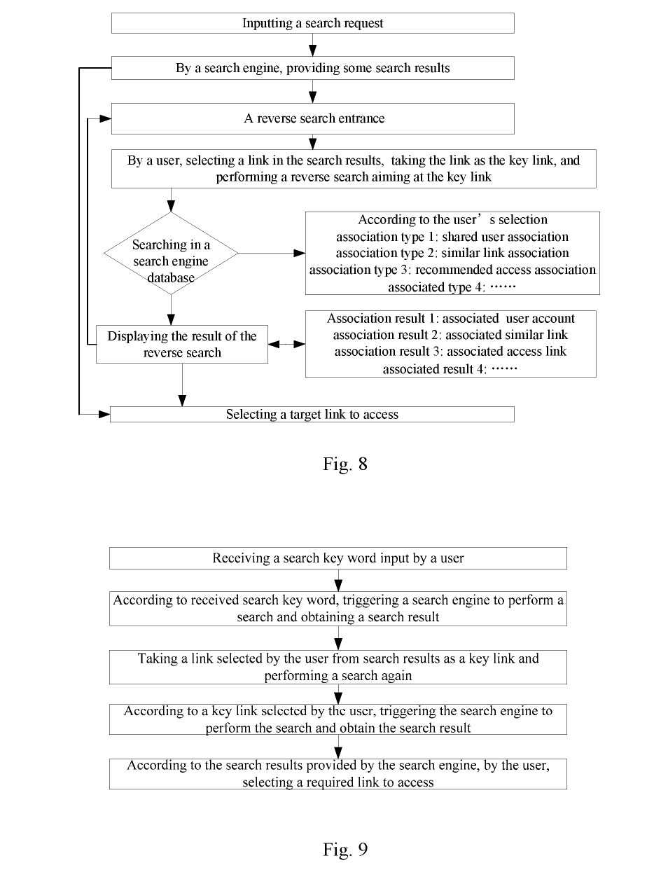

As shown in the FIG. 8, a search request is input, and a search engine provides some search results related with the search request; a user can directly selects a target link to access, or actuates a reverse search at a reverse search entrance, the search engine takes a link in the search results selected by the user as a key link, and performs the reverse search aiming at the key link; during searching the search engine database, a search is performed according to an associated type selected by the user, and thus the reverse search result is displayed. For example, when a default associated type is a shared user association, the obtained search result is an associated user account, the reverse search is further performed aiming at the associated user account, and associated links of the associated user are obtained; when a similar link association is selected by the user, coincidence webpages or coincidence webpage codes of which the contents are coincident with that of webpages or webpage codes corresponding to the key link are obtained and sequenced according to an order from a higher content comparison coincidence ratio to a lower content comparison coincidence ratio, and corresponding search results can be generated; when the user selects a recommended access association, the obtained results are all other recommended access associated links; finally, a target link is selected and accessed, or the reverse search is performed again.

1-5. (canceled)

6. A method for using a key link to execute a reverse search, comprising:
a: receiving a search request input by a user;
b: according to the received search request, triggering a search engine to perform a search, obtaining search results, and establishing a reverse search entrance corresponding to each of the search results;
c: by a user, selecting a link in the search results and taking the link as a key link, and generating a reverse search request aiming at the key link;
d: aiming at the reverse search request, actuating a search engine at the reverse search entrance and performing a reverse search, obtaining a pre-set associated user corresponding to the key link.

7. The method for using a key link to execute a reverse search according to claim 6, further comprising:
e: aiming at the associated user provided by the search engine, performing the reverse search again, and obtaining associated links of the associated user;
f: according to the search result provided by the search engine, by the user, selecting a required associated link to access, or performing the reverse search again.

8. The method for using a key link to execute a reverse search according to claim 6, wherein, when the reverse search is performed according to a similar link factor selected by the user, obtaining coincident webpages or webpage codes of which the contents are coincident with the contents of webpages/webpage codes corresponding to the key link, and sequencing the coincident webpages or webpage codes according to an order from a higher content comparison coincidence ratio to a lower content comparison coincidence ratio, and generating the corresponding search results.

9. The method for using a key link to execute a reverse search according to claim 6, wherein, when the reverse search is performed according to a common IP address factor selected by the user, obtaining all IP addresses corresponding to the key link; when the reverse search aiming at one of the IP addresses is performed again, obtaining all associated links accessed by the IP address.

10. The method for using a key link to execute a reverse search according to claim 6, wherein, when the reverse search is performed according to a sharer factor selected by the user, obtaining all sharers corresponding to the key link; and when a reverse search aiming at one of the sharers is performed again, obtaining all associated links shared by the sharer.

11. An apparatus for implementing the method according to claim 6, comprising:
a web crawler module configured for grabbing webpages in the Internet;
a search engine database configured for storing webpages or webpage codes grabbed by the web crawler module;
a user information managing module configured for managing user information, and establishing an information connection between the user information and associated links of the webpages and the webpage codes stored in the search engine database;
an input module configured for receiving a search request input by the user;
a retrieving module configured for searching in the search engine database according to the search request, and obtaining search results associated with the search request;
a displaying module configured for displaying the search results obtained by the retrieving module, and establishing a reverse search entrance corresponding to each of the search results simultaneously;
a reverse search module configured for obtaining associated information corresponding to the reverse search entrance from the search engine database according to the reverse search request, and generating corresponding search results and outputting the search results to the displaying module.

12. An apparatus for implementing the method according to claim 8, comprising:
a web crawler module configured for grabbing webpages in the Internet;
a search engine database configured for storing webpages or webpage codes grabbed by the web crawler module;
a user information managing module configured for managing user information, and establishing an information connection between the user information and associated links of the webpages and the webpage codes stored in the search engine database;
an input module configured for receiving a search request input by the user;
a retrieving module configured for searching in the search engine database according to the search request, and obtaining search results associated with the search request;
a displaying module configured for displaying the search results obtained by the retrieving module, and establishing a reverse search entrance corresponding to each of the search results simultaneously;
a reverse search module configured for obtaining associated information corresponding to the reverse search entrance from the search engine database according to the reverse search request, and generating corresponding search results and outputting the search results to the displaying module.
